(19) United States
(12) Patent Application Publication
(10) Pub. No.: US 2019/0326996 A1
(43) Pub. Date: Oct. 24, 2019

(54) OPTICAL MODULATOR

(71) Applicant: FUJITSU LIMITED, Kawasaki-shi (JP)

(72) Inventor: Hirotomo Izumi, Kawasaki (JP)

(73) Assignee: FUJITSU LIMITED, Kawasaki-shi (JP)

(21) Appl. No.: 16/374,775

(22) Filed: Apr. 4, 2019

(30) Foreign Application Priority Data
Apr. 19, 2018 (JP) 2018-080629

(51) Int. Cl. H04B 10/548

(52) U.S. Cl. CPC H04B 10/548

(57) ABSTRACT

An optical modulator includes an optical wave guide that passes light, a first phase shifter that adjusts a phase of the light passing through the optical waveguide by passing an electric current through a diode formed in the optical waveguide, a second phase shifter that adjusts a phase of the light passing through the optical waveguide by adjusting a temperature of the optical waveguide, and a controller that corrects a phase shift of the light passing through the optical waveguide based on a result of detection of power of the light that passed through the optical waveguide, the controller controls the first phase shifter to correct the phase shift when the magnitude of the phase shift of the light passing through the optical waveguide is less than a predetermined magnitude, and the controller controls the second shifter to correct the phase shift.

### CROSS-REFERENCE TO RELATED APPLICATION

This application is based upon and claims the benefit of priority of the prior Japanese Patent Application No. 2018-80629, filed on Apr. 19, 2018, the entire contents of which are incorporated herein by reference.

### FIELD

The embodiment discussed herein is related to an optical modulator.

### BACKGROUND

In the photo device of the Mach-Zehnder interferometer type, a technique that phase shifts to by diverting an electric current to the light guide of the arm having diode properties is known conventionally. In addition, in Mach-Zehnder modulator, a technique to apply a phase difference by giving a voltage to a phase adjustment heater of one arm is known

In the structure for performing phase shifting by using a diode in the above-described techniques, however, optical loss increases as the phase shift amount increases. In the structure for performing phase shifting by using a heater, it is difficult to follow and correct slight phase shifts.

The followings are reference documents.

### [Document 1] Japanese Laid-open Patent Publication No. 2016-133664 and

### [Document 2] Japanese Laid-open Patent Publication No. 2017-111338.

### SUMMARY

According to an aspect of the embodiments, an optical modulator includes an optical wave guide that passes light, a first phase shifter that adjusts a phase of the light passing through the optical waveguide by passing an electric current through a diode formed in the optical waveguide, a second phase shifter that adjusts a phase of the light passing through the optical waveguide by adjusting a temperature of the optical waveguide, and a controller that corrects a phase shift of the light passing through the optical waveguide based on a result of detection of power of the light that passed through the optical waveguide, the controller controls the first phase shifter to correct the phase shift when the magnitude of the phase shift of the light passing through the optical waveguide is less than a predetermined magnitude, and the controller controls the second shifter to correct the phase shift when the magnitude of the phase shift is greater than or equal to the predetermined magnitude.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an optical modulator according to an embodiment;

FIG. 2 is a graph of example current characteristics of a diode used for a phase shifter according to an embodiment;

FIG. 3 is a graph of example voltage characteristics of a diode for a phase shifter according to an embodiment;

FIG. 4 is a graph of an example phase difference with respect to optical power characteristics in an optical modulator according to an embodiment;

FIG. 5 is a graph of an example rough adjustment of a modulation operating point by a heater according to an embodiment;

FIG. 6 is a graph of an example modulation operating point drift in an optical modulator according to an embodiment;

FIG. 7 illustrates another example optical modulator according to an embodiment;

FIG. 8 illustrates example heater settings in an optical modulator according to an embodiment;

FIG. 9 illustrates example low-speed phase shifter settings in an optical modulator according to an embodiment; and

FIG. 10 is a flowchart of example processing to be performed by an optical modulator according to an embodiment.

### DESCRIPTION OF EMBODIMENTS

Hereinafter, an embodiment of an optical modulator will be described with reference to the attached drawings.

### Embodiment

### [Optical Modulator According to Embodiment]

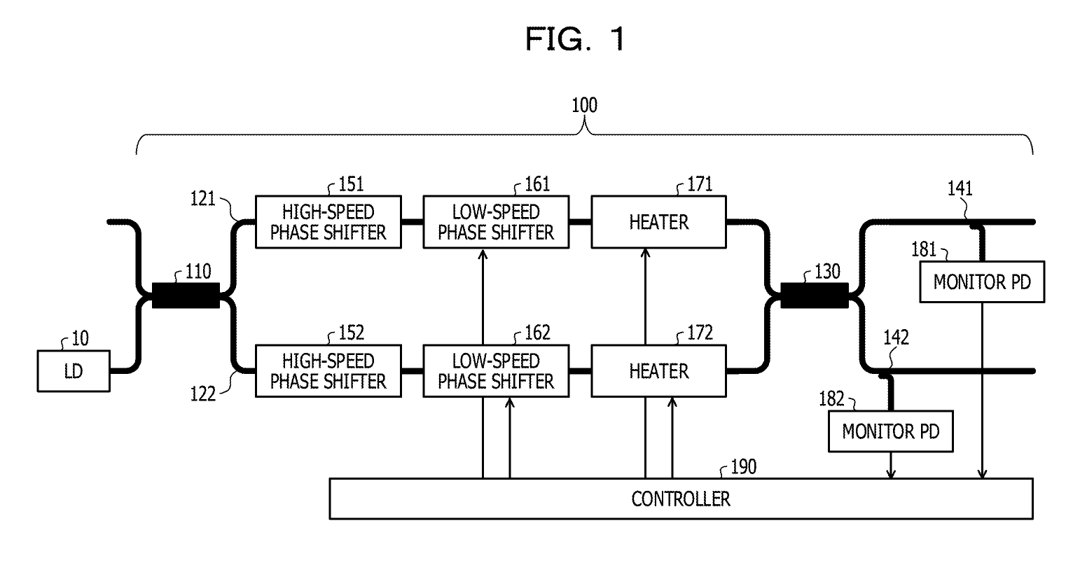

FIG. 1 illustrates an optical modulator according to an embodiment. A laser diode (LD) 10 illustrated in FIG. 1 generates light and outputs the light to an optical modulator 100. The LD 10 outputs continuous light. The optical modulator 100 according to the embodiment performs intensity modulation of the light output from the LD 10 to generate optical signals. The optical modulator 100 is, for example, a silicon type modulator formed using a silicon substrate.

The optical modulator 100 includes, for example, a splitting section 110, parallel waveguides 121 and 122, an interference section 130, and splitting sections 141 and 142. The splitting section 110, the parallel waveguides 121 and 122, the interference section 130, and the splitting sections 141 and 142 serve as, for example, an optical waveguide in a silicon substrate. The optical modulator 100 also includes high-speed phase shifters 151 and 152, low-speed phase shifters 161 and 162, heaters 171 and 172, monitor photo detectors (PDs) 181 and 182, and a controller 190.

The splitting section 110 splits the light output from the LD 10 and outputs one of the split lights to the parallel waveguide 121 and the other split light to the parallel waveguide 122. The splitting section 110 is, for example, a 2-input 2-output optical coupler.

The parallel waveguides 121 and 122 are disposed in parallel with each other. Each of the parallel waveguides 121 and 122 passes the light output from the splitting section 110 and outputs the light to the interference section 130. Optical path lengths of the parallel waveguides 121 and 122 are substantially equal, however, may be slightly different due to fabrication errors, age deterioration, or the like. Hereinafter, the side of the parallel waveguide 121 is referred to as an Upper side and the side of the parallel waveguide 122 is referred to as a Lower side.

The interference section 130 causes lights output from the parallel waveguides 121 and 122 to interfere with each other and outputs the lights obtained as a result of the interference to the splitting sections 141 and 142 respectively. The interference section 130 is, for example, a 2-input 2-output optical coupler.

The splitting section 141 splits the light output from the interference section 130 and outputs one of the split lights to a subsequent stage in the optical modulator 100 and the other split light to the monitor PD 181. The splitting section 142 splits the light output from the interference section 130 and outputs one of the split lights to a subsequent stage in the optical modulator 100 and the other split light to the monitor PD 182. The splitting sections 141 and 142 respectively output, for example, a part of the light output from the interference section 130 to the monitor PDs 181 and 182, for example, by optical couplers having a split ratio of 90:10 or 95:5, and allows the rest of the light to pass through to a subsequent stage in the optical modulator 100. The light output to a subsequent stage in the optical modulator 100 may be only one of the lights output from the splitting section 141 and the splitting section 142.

Each of the high-speed phase shifters 151 and 152 and the low-speed phase shifters 161 and 162 is a diode having a pn junction formed in the silicon substrate of the optical modulator 100. The refractive index of the diode varies in accordance with the current flowing through the diode in the silicon substrate, and thus phase modulation of the light passing through the diode is performed. The diode may be, for example, a positive-intrinsic-negative (PIN) diode.

The high-speed phase shifter 151 is disposed in the parallel waveguide 121, and the high-speed phase shifter 152 is disposed in the parallel waveguide 122. The high-speed phase shifters 151 and 152 serve as a data modulation section that performs phase modulation (phase shifting) of the lights passing through the parallel waveguides 121 and 122 respectively in accordance with a data signal input from a drive circuit (not illustrated). The high-speed phase shifters 151 and 152 may be, for example, phase shifters that operate faster than the low-speed phase shifters 161 and 162 so as to perform phase modulation in accordance with a high-speed data signal.

The low-speed phase shifters 161 and 162 and the heaters 171 and 172 are phase shifters for adjusting a modulation operating point (bias) of the optical modulator 100. The low-speed phase shifter 161 is disposed in the parallel waveguide 121, and the low-speed phase shifter 162 is disposed in the parallel waveguide 122. The low-speed phase shifters 161 and 162 perform phase modulation of the lights passing through the parallel waveguides 121 and 122 respectively in accordance with voltages applied from the controller 190. The low-speed phase shifters 161 and 162 may be, for example, phase shifters that operate slower than the above-described high-speed phase shifters 151 and 152 and operates faster than the heaters 171 and 172, which will be described below.

The heater 171 is disposed along the parallel waveguide 121, and the heater 172 is disposed along the parallel waveguide 122. The heaters 171 and 172 are phase shifters that perform phase modulation of the lights passing through the parallel waveguides 121 and 122 respectively in accordance with voltages applied by the controller 190. The refractive index of the parallel waveguides 121 and 122 varies by varying the temperature of the parallel waveguides 121 and 122 in the silicon substrate, and thus phase modulation of the lights passing through the parallel waveguides 121 and 122 is performed. The heaters 171 and 172 may be, for example, hating wires.

The monitor PDs 181 and 182 convert the lights output from the splitting sections 141 and 142 into electric signals respectively, and output the converted electric signals to the controller 190. The monitor PDs 181 and 182, for example, operate at a low speed relative to a rate of data signal that is input to the high-speed phase shifters 151 and 152. Accordingly, while the high-speed phase shifters 151 and 152 are being driven, an average value of the optical output power of the optical modulator 100, that is, the optical output power of the optical modulator 100 at a modulation operation point is measured.

The controller 190 applies voltages to the low-speed phase shifters 161 and 162 respectively and regulates the respective voltages applied to the low-speed phase shifters 161 and 162 so as to adjust currents flowing through the low-speed phase shifters (diodes) 161 and 162. With this operation, amounts of phase shift of the respective lights in the low-speed phase shifters 161 and 162 are regulated.

The controller 190 applies voltages to the heaters 171 and 172 respectively and regulates the respective voltages applied to the heaters 171 and 172 so as to adjust the temperatures around the heaters 171 and 172 in the parallel waveguides 121 and 122. With this operation, amounts of phase shift of the respective lights around the heaters 171 and 172 in the parallel waveguides 121 and 122 are regulated.

The controller 190 regulates the voltages to be applied to the low-speed phase shifters 161 and 162 and the voltages to be applied to the heaters 171 and 172 in accordance with electric signals output from the monitor PDs 181 and 182 respectively. For example, based on the electric signals output from the monitor PDs 181 and 182, the controller 190 determines the magnitude and direction of the phase shift of each light that interferes in the interference section 130, and regulates the voltage to be applied so as to correct the phase shift. The phase shift is a shift from an optimum phase state of each of the lights passing through the parallel waveguides 121 and 122, for example, a shift from an optimum point of a modulation operating point, which will be described below. The phase-shift correction is performed to reduce a phase shift, that is, to make a modulation operating point closer to an optimum point.

In the parallel waveguide 121 illustrated in FIG. 1, for example, from a preceding stage, the high-speed phase shifter 151, the low-speed phase shifter 161, and the heater 171 are disposed in this order, however, this order may be changed. For example, the positions of the low-speed phase shifter 161 and the heater 171 may be changed. Similarly, in the parallel waveguide 122, from a preceding stage, the high-speed phase shifter 152, the low-speed phase shifter 162, and the heater 172 are disposed in this order, however, this order may be changed.

Alternatively, the high-speed phase shifter 151 or the low-speed phase shifter 161 and the heater 171 may be disposed at the same position in the parallel waveguide 121. In such a case, the heater 171 adjusts the temperature of a portion where the diode of the high-speed phase shifter 151 or the low-speed phase shifter 161 is disposed in the parallel waveguide 121. Similarly, the high-speed phase shifter 152 or the low-speed phase shifter 162 and the heater 172 may be disposed at the same position in the parallel waveguide 122.

[Current Characteristics of Diode Used for Phase Shifter According to Embodiment]

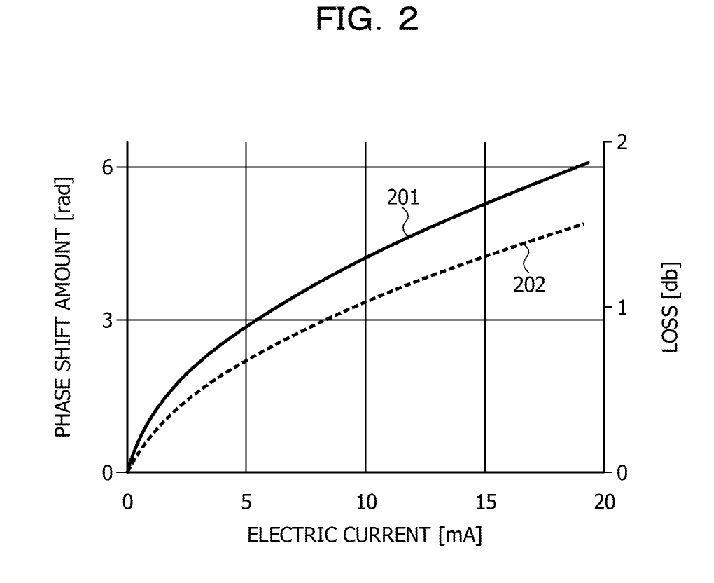

FIG. 2 is a graph of example current characteristics of a diode used for a phase shifter according to the embodiment. In FIG. 2, the horizontal axis represents current [mA] and the vertical axis represents phase shift amount [rad] and loss [dB] of light.

A current to shift amount characteristic 201 represents a characteristic of a phase shift amount [rad] of the light that passes through the diode (PIN diode) used for the low-speed phase shifters 161 and 162 with respect to a current [mA] that flows through the diode used for the low-speed phase shifters 161 and 162. The current to shift amount characteristic 201 means that as greater current flows through the diode, the phase shift amount of the light passing through the diode increases.

A current to loss characteristic 202 represents a characteristic of loss [dB] of the light that passes through the diode used for the low-speed phase shifters 161 and 162 with respect to a current [mA] that flows through the diode used for the low-speed phase shifters 161 and 162. The current to loss characteristic 202 means that as greater current flows through the diode, the loss of light passing through the diode increases due to the light absorption effect. In other words, as greater current flows through the diode, the shift amount of the light increases and the loss of light passing through the diode increases correspondingly. The low-speed phase shifters 161 and 162 that use the diode response faster than the phase shifting by the heaters 171 and 172.

[Voltage Characteristics of Diode Used for Phase Shifter According to Embodiment]

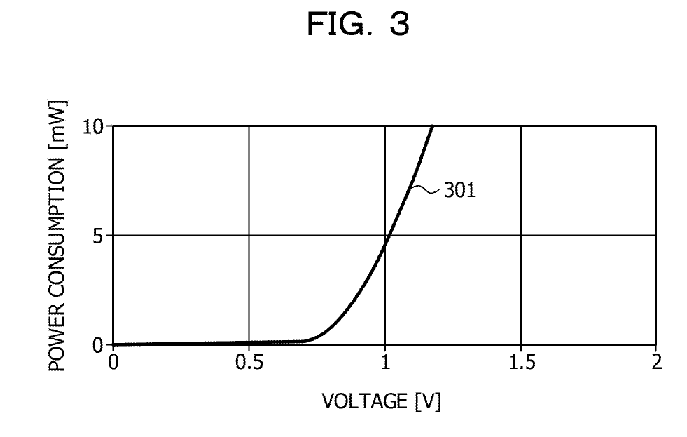

FIG. 3 is a graph of example voltage characteristics of the diode used for the phase shifters according to the embodiment. In FIG. 3, the horizontal axis represents voltage [V] and the vertical axis represents power consumption [mW]. A voltage to power consumption characteristic 301 represents a characteristic of power consumption in the low-speed phase shifters 161 and 162 with respect to a voltage [V] that is applied to the diodes used for the low-speed phase shifters 161 and 162. The voltage to power consumption characteristic 301 means that as greater voltage is applied to the diode, the power consumption increases.

[Phase Difference to Optical Power Characteristics in Optical Modulator According to Embodiment]

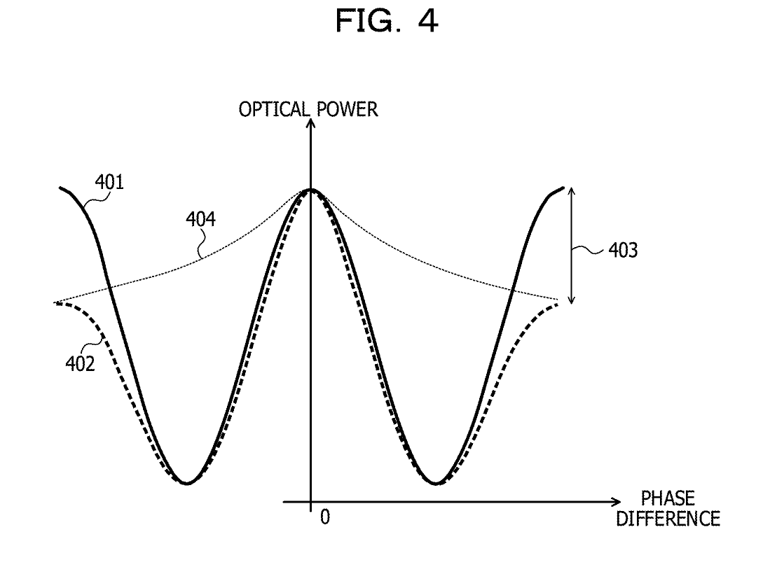

FIG. 4 is a graph of example phase difference to optical power characteristics in an optical modulator according to the embodiment. In FIG. 4, the horizontal axis represents a phase difference of lights that pass through the parallel waveguides 121 and 122 and the vertical axis represents optical power. A phase difference between the lights that pass through the parallel waveguides 121 and 122 is obtained, for example, by subtracting a phase of the light that passes through the parallel waveguide 122 from a phase of the light that passes through the parallel waveguide 121. Specifically, as the phase difference between the lights that pass through the parallel waveguides 122 and 121 increases, the phase of the light that passes through the parallel waveguide 121 advances or delays with respect to the light that passes through the parallel waveguide 122.

A phase difference to optical power characteristic 401 represents a characteristic of power (optical output power) of the light output from the interference section 130 with respect to a phase difference applied by the heaters 171 and 172 to the lights that pass through the parallel waveguides 121 and 122. The phase difference to optical power characteristic 401 means that the optical output power periodically changes in accordance with phase difference changes applied by the heaters 171 and 172 to the lights that pass through the parallel waveguides 121 and 122. Since the phase shift due to the heaters 171 and 172 causes no light absorption effect, the optical output power is not attenuated by the increased phase difference between the lights passing through the parallel waveguides 121 and 122 due to the heaters 171 and 172.

A phase difference to optical power characteristic 402 represents a characteristic of the optical output power with respect to a phase difference applied by the low-speed phase shifters 161 and 162 to the lights that pass through the parallel waveguides 121 and 122. The phase difference to optical power characteristic 402 means that the optical output power periodically changes in accordance with phase difference changes applied by the low-speed phase shifters 161 and 162 to the lights that pass through the parallel waveguides 121 and 122. However, the phase shift applied to the low-speed phase shifters 161 and 162 causes the light absorption effect, so the increased phase difference between the lights passing through the parallel waveguides 121 and 122 due to the low-speed phase shifters 161 and 162 causes an attenuation 403 of the optical output power. An attenuation curve 404 represents the attenuation of the optical power due to the low-speed phase shifters 161 and 162.

Accordingly, if the phase difference is regulated only by the low-speed phase shifters 161 and 162 with respect to the lights that pass through the parallel waveguides 121 and 122, the light loss increases with the phase difference. Consequently, for example, in order to compensate for the loss of light, the output of the LD 10 is increased, and thus the power consumption of the optical modulator 100 increases.

On the other hand, if the phase difference is regulated only by the heaters 171 and 172 with respect to the lights that pass through the parallel waveguides 121 and 122, it takes time to adjust the temperature by the heaters 171 and 172, and the speed of response to a slight phase shift of the lights decreases. Accordingly, for example, the quality (for example, the extinction ratio) of the optical signal obtained by the optical modulator 100 decreases.

The optical modulator 100 according to the embodiment adjusts phase differences between the lights passing through the parallel waveguides 121 and 122 by using both the low-speed phase shifters 161 and 162 and the heaters 171 and 172 so as to reduce optical loss. Accordingly, for example, deterioration in the quality of optical signals and increase in power consumption are reduced.

[Rough Adjustment of Modulation Operating Point by Heater According to Embodiment]

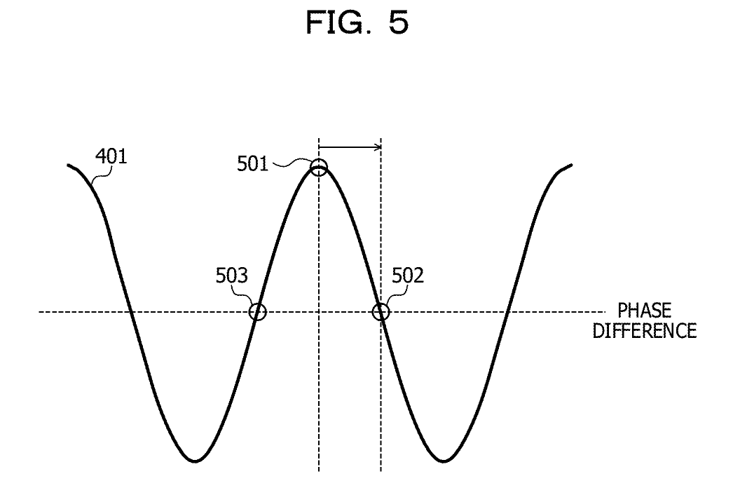

FIG. 5 is a graph of an example rough adjustment of a modulation operating point by heaters according to the embodiment. In FIG. 5, to portions similar to those in FIG. 4, the same reference numerals are given, and their descriptions are omitted. The voltage applied to the heaters 171 and 172 are regulated to make rough adjustments to modulation operating points of the optical modulator 100 in the phase difference to optical power characteristic 401.

Modulation operating points of the optical modulator 100 may be phase differences between the lights passing through the parallel waveguides 121 and 122 when the high-speed phase shifters 151 and 152 perform no modulation in accordance with a data signal. The modulation operating points of the optical modulator 100 may be centers (average values) in ranges of changes in phase differences between the lights passing through the parallel waveguides 121 and 122 while the high-speed phase shifters 151 and 152 is performing modulation in accordance with a data signal.

For example, in a reference state, the voltages applied to the heaters 171 and 172 are regulated respectively to regulate the temperatures around the heaters 171 and 172 to 40° C. In this state, it is assumed that a modulation operating point of the optical modulator 100 in the reference state is a modulation operating point 501. In the state in which the modulation operating point is set to the modulation operating point 501, the high-speed phase shifters 151 and 152 perform phase modulation in accordance with a data signal, and then the optical output power of the optical modulator 100 varies around a maximum value in accordance with the data signal. As a result, the intensity modulation in accordance with the data signal is not appropriately performed.

In such a case, the optical modulator 100, for example, increases the voltage applied to the heater on the Upper side to increase the temperature around the heater 171 to change the phase of the light passing through the parallel waveguide 121, setting the modulation operating point to a modulation operating point 502 that is an optimum point. In the state in which the modulation operating point is set to the modulation operating point 502, the high-speed phase shifters 151 and 152 perform phase modulation in accordance with a data signal, and then the optical output power of the optical modulator 100 changes to a minimum value and a maximum value in accordance with the data signal. Accordingly, the intensity modulation in accordance with the data signal is appropriately performed.

Alternatively, the optical modulator 100 increases the voltage applied to the heater on the Lower side to increase the temperature around the heater 172 to change the phase of the light passing through the parallel waveguide 122, setting the modulation operating point to a modulation operating point 503 that is another optimum point. In the state in which the modulation operating point is set to the modulation operating point 503, the high-speed phase shifters 151 and 152 perform phase modulation in accordance with a data signal, and then the optical output power of the optical modulator 100 changes to a minimum value and a maximum value in accordance with the data signal. Accordingly, the intensity modulation in accordance with data signals is appropriately performed.

Note that the phase differences between the lights interfering in the interference section 130 may differ in each individual optical modulator 100, for example, due to manufacturing errors in the optical path lengths of the parallel waveguides 121 and 122. Accordingly, the above-described adjustment of modulation operating points may be performed for each individual optical modulator 100.

[Modulation Operating Point Drift in Optical Modulator According to Embodiment]

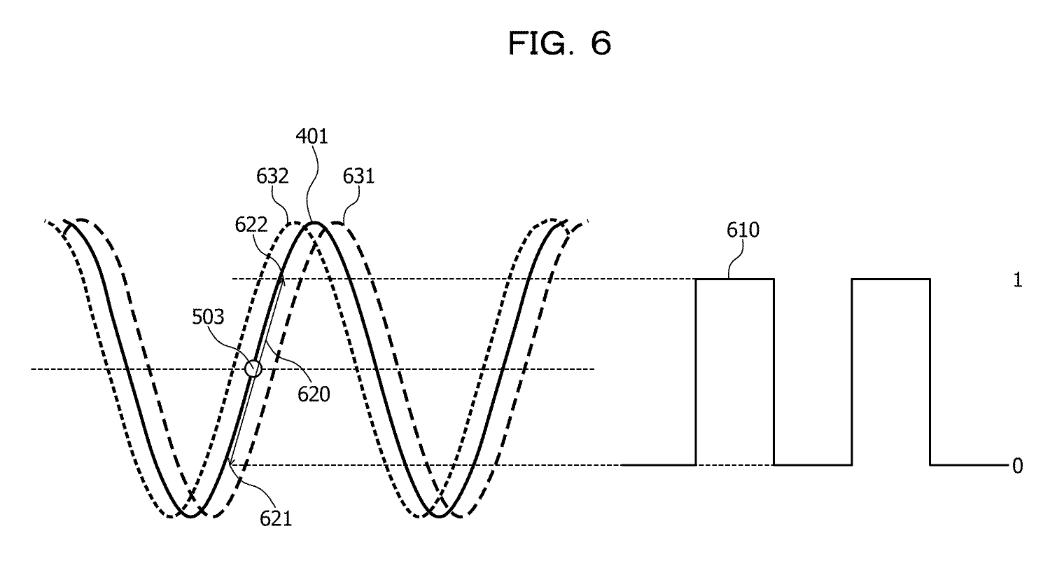

FIG. 6 is a graph of an example modulation operating point drift in an optical modulator according to the embodiment. In FIG. 6, to portions similar to those in FIG. 5, the same reference numerals are given, and their descriptions are omitted. When a modulation operating point is set to the modulation operating point 503, the high-speed phase shifters 151 and 152 perform phase modulation in accordance with a data signal 610, and then the optical output power of the optical modulator 100 varies within an operation range 620.

For example, the optical output power of the optical modulator 100 becomes minimum power 621 when a value of the data signal 610 is “0” and becomes maximum power 622 when a value of the data signal 610 is “1”. As a result, the intensity modulation (on/off of light) in accordance with the data signal 610 is appropriately performed.

While the optical modulator 100 is in operation, however, due to age deterioration, ambient temperature variation, or the like, the phase difference to optical power characteristic 401 may change like a phase difference to optical power characteristic 631 or a phase difference to optical power characteristic 632, and a drift may occur, that is, modulation operating points may fluctuate in a phase direction. When the fluctuation is minute and the heaters 171 and 172 may not follow the fluctuation speed, the low-speed phase shifters 161 and 162 having the diodes are used to adjust the phase differences.

[Other Optical Modulators According to Embodiment]

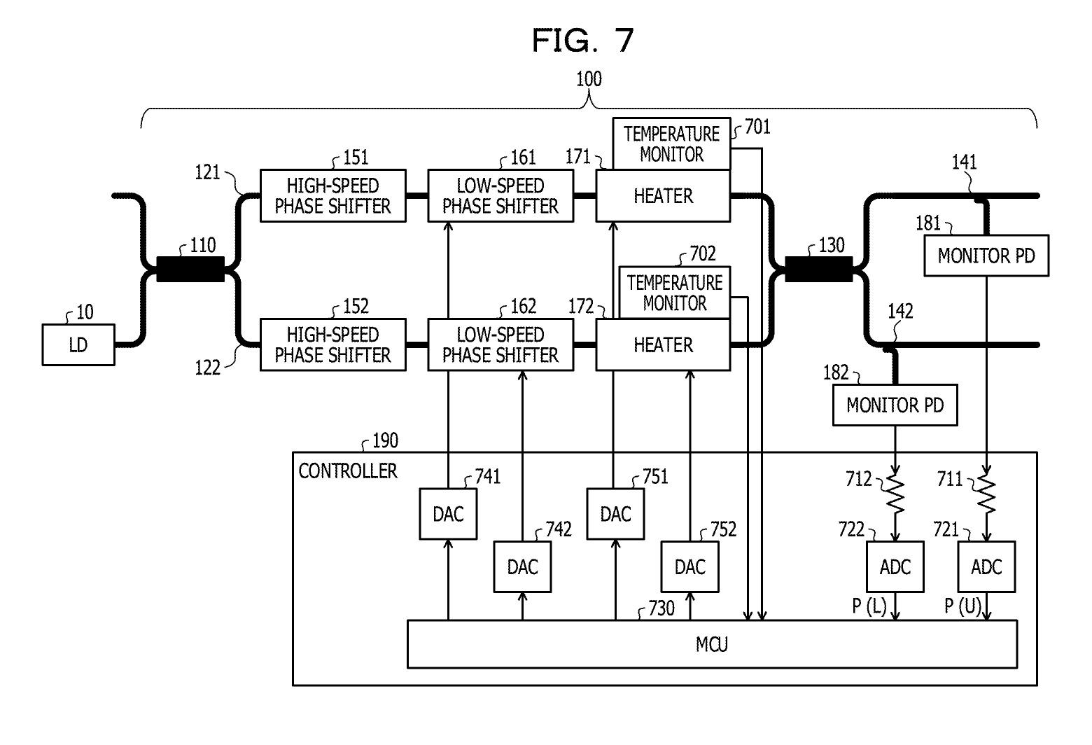

FIG. 7 illustrates another example optical modulator according to the embodiment. In FIG. 7, to components similar to those in FIG. 1, the same reference numerals are given, and their descriptions are omitted. As illustrated in FIG. 7, the optical modulator 100 may include temperature monitors 701 and 702 in addition to the structure illustrated in FIG. 1. The temperature monitors 701 and 702 measure the temperatures of the heaters 171 and 172 respectively, and out the temperature information that indicates the measured temperatures to the controller 190.

The controller 190 includes, for example, resistors 711 and 712, analog-to-digital converters (ADCs) 721 and 722, a microcontroller unit (MCU) 730, and digital-to-analog converters (DACs) 741, 742, 751, and 752.

The resistors 711 and 712 convert electric signals output from the monitor PDs 181 and 182 respectively from current signals into voltage signals. The resistors 711 and 712 output the converted electric signals to the ADCs 721 and 722 respectively. The electric signal output from the resistor 711 to the ADC 721 is a signal that indicates optical power P(U) at the splitting section 141 on the Upper side by voltage. The electric signal output from the resistor 712 to the ADC 722 is a signal that indicates optical power P(L) at the splitting section 142 on the Lower side by voltage.

The ADCs 721 and 722 convert electric signals output from the resistors 711 and 712 respectively from analog signals into digital signals. The ADC 721 outputs the converted electric signal as optical power information indicating optical power P(U) to the MCU 730. The ADC 722 outputs the converted electric signal as optical power information indicating optical power P(L) to the MCU 730.

The MCU 730 outputs digital voltage information that indicates voltages to be applied to the low-speed phase shifters 161 and 162 to the DACs 741 and 742 respectively. The MCU 730 also outputs digital voltage information that indicates voltages to be applied to the heaters 171 and 172 to the DACs 751 and 752 respectively. The MCU 730 adjusts digital signals to be output to the DACs 751 and 752 such that the temperatures of the heaters 171 and 172 indicated by temperature information output from the temperature monitors 701 and 702 become target temperatures, which will be described below, respectively.

The MCU 730 controls voltage information to be output to the DACs 741, 742, 751, and 752 based on optical power P(U) and optical power P(L) indicated by optical power information output from the ADCs 721 and 722.

The DACs 741 and 742 convert digital voltage signals output from the MCU 730 into analog voltages and apply the converted voltages to the low-speed phase shifters 161 and 162 respectively. The DACs 751 and 752 convert digital voltage signals output from the MCU 730 into analog voltages and apply the converted voltages to the heaters 171 and 172 respectively.

[Heater Settings Set by Optical Modulator According to Embodiment]

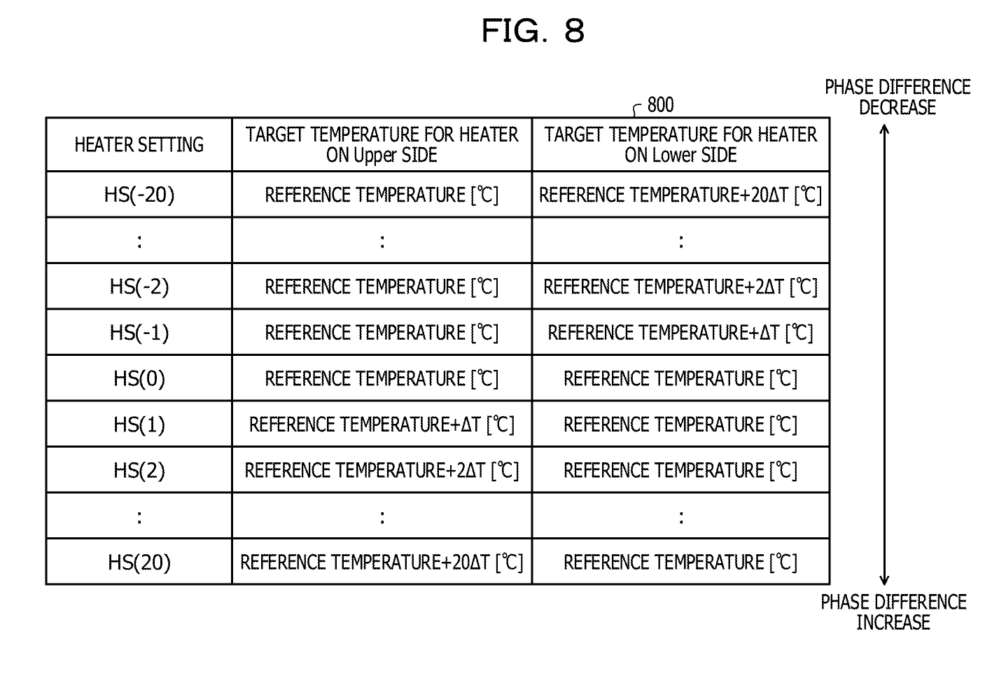

FIG. 8 illustrates example heater settings in an optical modulator according to the embodiment. A table 800 in FIG. 8 illustrates settings to be applied to the heaters 171 and 172 by the MCU 730 in the optical modulator 100.

Heater settings HS(−20) to HS(20) in the table 800 are settings of target temperatures for the heaters 171 and 172 in which phase differences are different from each other by one step, the phase differences to be applied by the heaters 171 and 172 to the lights passing through the parallel waveguides 121 and 122. In the table 800, a target temperature for the heater on the Upper side indicates a target temperature for the heater 171. In the table 800, a target temperature for the heater on the Lower side indicates a target temperature for the heater 172.

The MCU 730 selects one of the heater settings HS(−20) to HS(20) in controlling the heaters 171 and 172. The MCU 730 adjusts voltage information to be output to the DAC 751 such that the temperature information to be output from the temperature monitor 701 becomes a target temperature for the heater on the Upper side that corresponds to the selected heater setting. The MCU 730 also adjusts voltage information be output to the DAC 752 such that the temperature information to be output from the temperature monitor 702 becomes a target temperature for the heater on the Lower side that corresponds to the selected heater setting.

For example, the heater setting HS(0) is a reference setting, and is a setting for regulating the temperatures of the heaters 171 and 172 to become a predetermined reference temperature. The reference temperature is, for example, 40° C.

The heater setting HS(1) is a setting in which a phase difference to be applied to the lights by the heaters 171 and 172 is increased by one step with respect to the heater setting HS(0). The heater sitting HS(1) is for regulating the temperature of the heater 171 to become the reference temperature+ΔT, and for regulating the temperature of the heater 172 to become the reference temperature. ΔT denotes a temperature of a predetermined unit, for example, 1° C.

The heater setting HS(2) is a setting in which a phase difference to be applied to the lights by the heaters 171 and 172 is increased by one step with respect to the heater setting HS(1). The heater sitting HS(2) is for regulating the temperature of the heater 171 to become the reference temperature+2ΔT, and for regulating the temperature of the heater 172 to become the reference temperature. As described above, the heater settings HS(1) to HS(20) are settings in which target temperatures for the heater 171 are increased by ΔT with respect to the reference heater setting HS(0) respectively.

The heater setting HS(−1) is a setting in which a phase difference to be applied to the lights by the heaters 171 and 172 is decreased by one step with respect to the heater setting HS(0). The heater sitting HS(−1) is for regulating the temperature of the heater 171 to become the reference temperature, and for regulating the temperature of the heater 172 to become the reference temperature+ΔT.

The heater setting HS(−2) is a setting in which a phase difference to be applied to the lights by the heaters 171 and 172 is decreased by one step with respect to the heater setting HS(−1). The heater sitting HS(−2) is for regulating the temperature of the heater 171 to become the reference temperature, and for regulating the temperature of the heater 172 to become the reference temperature+2ΔT. As described above, the heater settings HS(−1) to HS(−20) are settings in which target temperatures for the heater 172 are increased by ΔT with respect to the reference heater setting HS(0) respectively.

As illustrated in FIG. 8, with respect to the predetermined reference temperature, by changing the temperature of the heater 171 or the heater 172, a phase difference to be applied to the lights passing through the parallel waveguides 121 and 122 by the heaters 171 and 172 are increased or decreased.

[Low-Speed Phase Shifter Settings Set by Optical Modulator According to Embodiment]

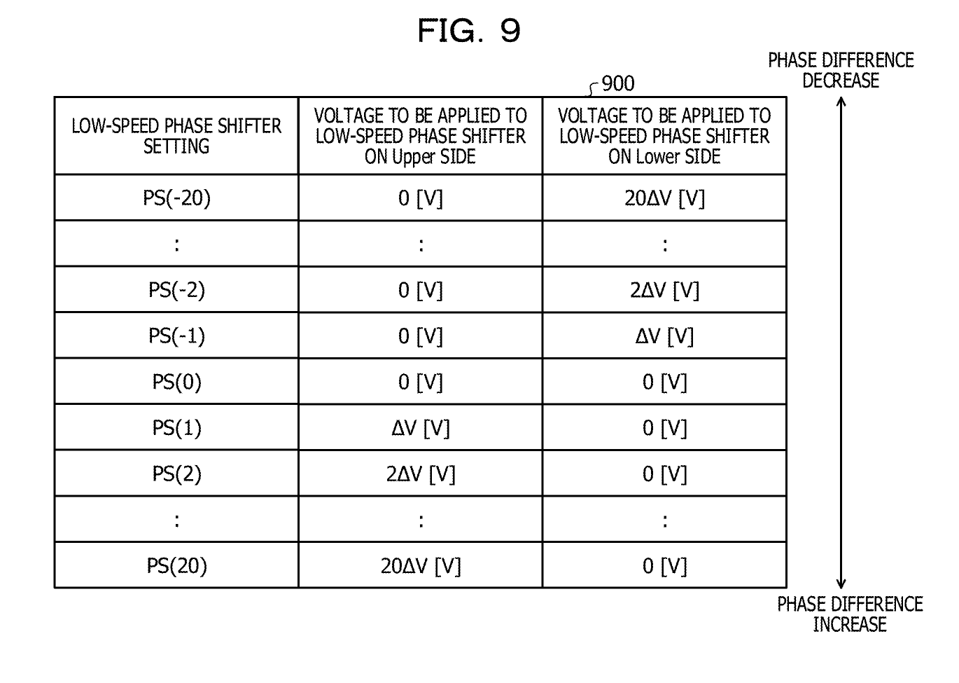

FIG. 9 illustrates example low-speed phase shifter settings in the optical modulator according to the embodiment. A table 900 in FIG. 9 illustrates settings to be applied to the low-speed phase shifters 161 and 162 by the MCU 730 in the optical modulator 100.

Low-speed phase shifter settings PS(−20) to PS(20) in the table 900 are settings of voltages to be applied to the low-speed phase shifters 161 and 162 in which phase differences are different from each other by one step, the phase differences to be applied by the low-speed phase shifters 161 and 162 to the lights passing through the parallel waveguides 121 and 122. In the table 900, a voltage to be applied to the low-speed phase shifter on the Upper side indicates a voltage to be applied to the low-speed phase shifter 161. In the table 900, a voltage to be applied to the low-speed phase shifter on the Lower side indicates a voltage to be applied to the low-speed phase shifter 162.

The MCU 730 selects one of the low-speed phase shifter settings PS(−20) to PS(20) in controlling the low-speed phase shifters 161 and 162. The MCU 730 outputs voltage information that indicates a voltage to be applied to the low-speed phase shifter on the Upper side that corresponds to the selected low-speed phase shifter setting to the DAC 741. The MCU 730 also outputs voltage information that indicates a voltage to be applied to the low-speed phase shifter on the Lower side that corresponds to the selected low-speed phase shifter setting to the DAC 742.

For example, the low-speed phase shifter setting PS(0) is a reference setting, and is a setting for regulating the voltages to be applied to the low-speed phase shifters 161 and 162 to become 0 V, that is, a setting for not passing current through the diodes.

The low-speed phase shifter setting PS(1) is a setting in which a phase difference to be applied to the lights by the low-speed phase shifters 161 and 162 is increased by one step with respect to the low-speed phase shifter setting PS(0). For example, the low-speed phase shifter setting PS(1) is a setting for regulating the voltage to be applied to the low-speed phase shifter 161 to become ΔV, and for regulating the voltage to be applied to the low-speed phase shifter 162 to become 0 V. ΔV denotes a voltage of a predetermined unit.

The low-speed phase shifter setting PS(2) is a setting in which a phase difference to be applied to the lights by the low-speed phase shifters 161 and 162 is increased by one step with respect to the low-speed phase shifter setting PS(1). For example, the low-speed phase shifter setting PS(2) is a setting for regulating the voltage to be applied to the low-speed phase shifter 161 to become 2ΔV, and for regulating the voltage to be applied to the low-speed phase shifter 162 to become 0 V. As described above, the low-speed phase shifter settings PS(1) to PS(20) are settings in which voltages to be applied to the low-speed phase shifter 161 are increased by ΔV with respect to the reference low-speed phase shifter setting PS(0) respectively.

The low-speed phase shifter setting PS(−1) is a setting in which a phase difference to be applied to the lights by the low-speed phase shifters 161 and 162 is decreased by one step with respect to the low-speed phase shifter setting PS(0). For example, the low-speed phase shifter setting PS(−1) is a setting for regulating the voltage to be applied to the low-speed phase shifter 161 to become 0 V, and for regulating the voltage to be applied to the low-speed phase shifter 162 to become ΔV.

The low-speed phase shifter setting PS(−2) is a setting in which a phase difference to be applied to the lights by the low-speed phase shifters 161 and 162 is decreased by one step with respect to the low-speed phase shifter setting PS(−1). For example, the low-speed phase shifter setting PS(−2) is a setting for regulating the voltage to be applied to the low-speed phase shifter 161 to become 0 V, and for regulating the voltage to be applied to the low-speed phase shifter 162 to become 2ΔV. As described above, the low-speed phase shifter settings PS(−1) to PS(−20) are settings in which voltages to be applied to the low-speed phase shifter 162 are increased by ΔV with respect to the reference low-speed phase shifter setting PS(0) respectively.

As illustrated in FIG. 9, by applying a voltage to one of the low-speed phase shifter 161 and the low-speed phase shifter 162 and changing the voltage, a phase difference to be applied to the lights passing through the parallel waveguides 121 and 122 by the low-speed phase shifters 161 and 162 are increased or decreased.

[Processing to be Performed by Optical Modulator According to Embodiment]

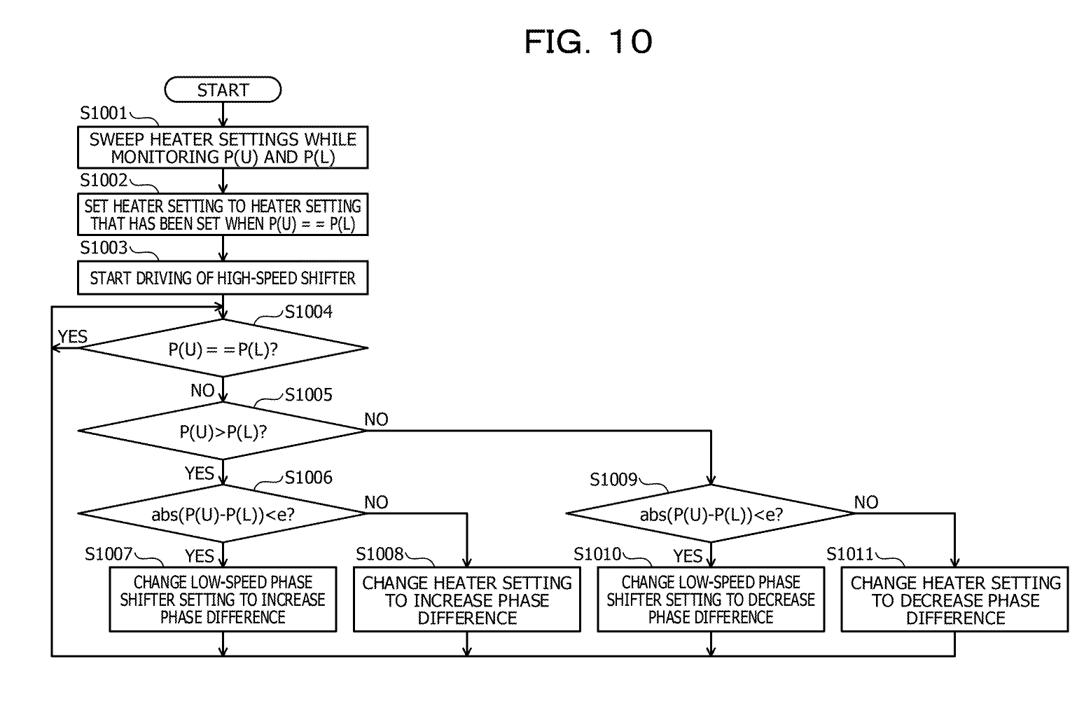

FIG. 10 is a flowchart of example processing to be performed by an optical modulator according to the embodiment. The optical modulator 100 according to the embodiment performs, for example, processing illustrated in FIG. 10. The processing illustrated in FIG. 10 is performed, for example, by the MCU 730 illustrated in FIG. 6. In an initial state, the LD 10 is emitting light, but the optical modulator 100 is not driving the high-speed phase shifters 151 and 152 and the low-speed phase shifters 161 and 162.

First, the optical modulator 100 sweeps heater settings while monitoring optical power P(U) and optical power P(L) based on electric signals output from the monitor PDs 181 and 182 (step S1001). For example, the optical modulator 100 obtains the optical power P(U) and P(L) while switching the settings of the heaters 171 and 172 from the heater setting HS(0), HS(1), HS(2), . . . , HS(20), HS(−1), HS(−2), . . . , HS(−20) in this order. In this processing, each time switching the heater settings, the optical modulator 100 waits until the temperatures indicated by the temperature information from the temperature monitors 701 and 702 reach the target temperatures for the heater setting, and obtains the optical power P(U) and P(L).

The order of sweeping the heater settings is not limited to this example, and may be performed in a different order. For example, the optical modulator 100 may switch the heater setting from the heater setting HS(0), HS(−1), HS(−2), . . . , HS(−20), HS(0), HS(1), HS(2), . . . , HS(20) in this order. In another example, the optical modulator 100 may switch the heater setting from the heater setting HS(−20), HS(−19), . . . , HS(−1), HS(0), HS(1), HS(2), . . . , HS(20) in this order. The optical modulator 100 may end the sweep of the heater settings when the obtained optical power P(U) and P(L) become equal.

Then, the optical modulator 100 sets the setting of the heaters 171 and 172 to the heater setting that has been set when the obtained optical power P(U) and P(L) become equal among the heater settings swept in step S1001 (step S1002). Alternatively, the optical modulator 100 may set the setting of the heaters 171 and 172 to the heater setting that has been set when a difference between the obtained optical power P(U) and P(L) becomes minimum. By the processing, the modulation operating points of the optical modulator 100 are set to optimum points (for example, the modulation operating points 502 and 503 illustrated in FIG. 5). In this example, a case in which a modulation operating point becomes the modulation operating point 503 will be described.

The optical modulator 100 starts the driving of the high-speed phase shifters 151 and 152, that is, the modulation based on a data signal (step S1003). Then, the optical modulator 100 determines whether the optical power P(U) and the optical power P(L) are equal based on the electric signals output from the monitor PDs 181 and 182 (step S1004). When the optical power P(U) and the optical power P(L) are equal (Step S1004: Yes), the optical modulator 100 determines that the modulation operating point is maintained at the optimum point. Then, the optical modulator 100 returns to step S1004.

In step S1004, when the optical power P(U) and the optical power P(L) are not equal (Step S1004: No), the optical modulator 100 determines that the modulation operating point is shifted from the optimum point due to age deterioration, ambient temperature variation, or the like. Then, the optical modulator 100 determines whether the optical power P(U) is higher than the optical power P(L) (Step S1005).

In step S1005, when the optical power P(U) is higher than the optical power P(L) (Step S1005: Yes), the optical modulator 100 determines whether the absolute value of the difference between the optical power P(U) and the optical power P(L) is smaller than a predetermined value e (Step S1006). The predetermined value e may be, for example, 0.5 mW. Note that the predetermined value e is not limited to this value, for example, a predetermined value may be used depending on output power of the LD 10, allowable optical loss, allowable deterioration in signal quality, or the like.

In step S1006, when the absolute value of the difference between the optical power P(U) and the optical power P(L) is smaller than the predetermined value e (Step S1006: Yes), the optical modulator 100 goes to step S1007. Specifically, the optical modulator 100 changes the low-speed phase shifter setting to a low-speed phase shifter setting in which a phase difference to be applied to the lights by the low-speed phase shifters 161 and 162 is increased by one step from the current phase difference (Step S1007). Then, the processing returns to step S1004. In step S1007, for example, when the low-speed phase shifter setting before the change is PS(0), the optical modulator 100 changes the low-speed phase shifter setting to PS(1).

In step S1006, when the absolute value of the difference between the optical power P(U) and the optical power P(L) is not smaller than the predetermined value e (Step S1006: No), the optical modulator 100 goes to step S1008. Specifically, the optical modulator 100 changes the heater setting to a heater setting in which a phase difference to be applied to the lights by the heaters 171 and 172 is increased by one step from the current phase difference (Step S1008). Then, the processing returns to step S1004. In step S1008, for example, when the heater setting before the change is HS(0), the optical modulator 100 changes the heater setting to HS(1).

In step S1005, when the optical power P(U) is not higher than the optical power P(L) (Step S1005: No), the optical modulator 100 determines whether the absolute value of the difference between the optical power P(U) and the optical power P(L) is smaller than the predetermined value e (Step S1009).

In step S1009, when the absolute value of the difference between the optical power P(U) and the optical power P(L) is smaller than the predetermined value e (Step S1009: Yes), the optical modulator 100 goes to step S1010. Specifically, the optical modulator 100 changes the low-speed phase shifter setting to a low-speed phase shifter setting in which a phase difference to be applied to the lights by the low-speed phase shifters 161 and 162 is decreased by one step from the current phase difference (Step S1010). Then, the processing returns to step S1004. In step S1010, for example, when the low-speed phase shifter setting before the change is PS(0), the optical modulator 100 changes the low-speed phase shifter setting to PS(−1).

In step S1009, when the absolute value of the difference between the optical power P(U) and the optical power P(L) is not smaller than the predetermined value e (Step S1009: No), the optical modulator 100 goes to step S1011. Specifically, the optical modulator 100 changes the heater setting of the heaters 171 and 172 to a heater setting in which a phase difference to be applied to the lights by the heaters 171 and 172 is decreased by one step from the current phase difference (Step S1011). Then, the processing returns to step S1004. In step S1011, for example, when the heater setting before the change is HS(0), the optical modulator 100 changes the heater setting to HS(−1).

As illustrated in FIG. 10, the optical modulator 100 compares the optical power P(U) and the optical power P(L) to determine the direction of the phase shift, and determines the magnitude of the phase shift based on the absolute value of the difference between the optical power P(U) and the optical power P(L). When the phase shift is small, the optical modulator 100 changes the low-speed phase shifter setting, and when the phase shift is large, the optical modulator 100 changes the heater setting to correct the phase shift.

In the above description, the case in which the modulation operating point becomes the modulation operating point 503 in step S1002 has been described. On the other hand, in step S1002, when the modulation operating point becomes the modulation operating point 502, the increase and decrease in the phase difference control from step S1005 to step S1011 are reversed. Specifically, in step S1005, when the optical power P(U) is higher than the optical power P(L) (Step S1005: Yes), the optical modulator 100 goes to step S1009. In step S1005, when the optical power P(U) is not higher than the optical power P(L) (Step S1005: No), the optical modulator 100 goes to step S1006.

The optical modulator 100 determines whether the modulation operating point has become the modulation operating point 502 or the modulation operating point 503 in step S1002, for example, based on a result of the sweep in step S1001. For example, when the optical power P(U) is higher than the optical power P(L) under a setting in which the phase difference to be applied to the lights is increased by one step from the heater setting that has been set when the optical power P(U) and the optical power P(L) are equal, the optical modulator 100 determines that the modulation operating point has become the modulation operating point 503. When the optical power P(U) is lower than the optical power P(L) under a setting in which the phase difference to be applied to the lights is increased by one step from the heater setting that has been set when the optical power P(U) and the optical power P(L) are equal, the optical modulator 100 determines that the modulation operating point has become the modulation operating point 502.

In the above-described example, in steps S1007, S1008, S1010, and S1011, the optical modulator 100 changes the heater setting or the low-speed phase shifter setting so as to change a phase difference by one step, however, the processing is not limited to this example. For example, the optical modulator 100 may change the heater setting or the low-speed phase shifter setting so as to change a phase difference by one step or more steps corresponding to an absolute value of a difference between the optical power P(U) and the optical power P(L).

In the above-described example, the optical modulator 100 changes the heater setting or the low-speed phase shifter setting based on the optical power P(U) and the optical power P(L); however, the processing is not limited to this example. For example, the optical modulator 100 may store P(U) (=P(L)) in the heater setting that is set in step S1001 as P(0), and the P(0) may be used instead of P(L) in steps S1004 to S1006 and S1009. By the processing, the direction and magnitude of a phase shift is determined by using the optical output power at an optimum point of modulation operating points as a reference.

As described above, when a phase shift is relatively small, the optical modulator 100 according to the embodiment controls the low-speed phase shifters 161 and 162 (first phase shifter) that use the diodes to correct the phase shift. Accordingly, the response speed to a slight phase shift is increased. The magnitude of a phase shift may be, for example, the above-described absolute value of a difference between P(U) and P(L).

When a phase shift is relatively large, the optical modulator 100 controls the heaters 171 and 172 (second phase shifter) that use temperature adjustment to correct the phase shift. By the processing, optical loss in correcting a large phase shift is reduced.

Consequently, the optical modulator 100 according the embodiment reduces optical loss while following and correcting a slight phase shift. Accordingly, for example, an increase in power consumption is reduced while reducing deterioration in the quality of optical signals obtained by the optical modulator 100.

For example, the low-speed phase shifters 161 and 162 may adjust a phase difference between the lights passing through the parallel waveguides 121 and 122 by passing an electric current through the diodes in the parallel waveguides 121 and 122. Furthermore, the heaters 171 and 172 may adjust a phase difference between the lights passing through the parallel waveguides 121 and 122 by regulating the temperatures of the parallel waveguides 121 and 122.

In this case, the above-described phase shift is a shift from a predetermined value (optimum point) of an average value (modulation operating point) of phase differences of lights that pass through the parallel waveguides 121 and 122 and interfere in the interference section 130. The optical modulator 100 determines the magnitude of a phase shift based on the power of lights obtained by the interference of lights in the interference section 130.

The optical modulator 100 may correct, before phase modulation is started by the high-speed phase shifters 151 and 152, a phase shift by regulating the heaters 171 and 172 irrespective of the magnitude of the phase shift. In such a case, after the start of the phase modulation by the high-speed phase shifters 151 and 152, the optical modulator 100 regulates the low-speed phase shifters 161 and 162 or the heaters 171 and 172 depending on the magnitude of the phase shift as described above to correct the phase shift. By the processing, a phase shift due to a manufacturing error or the like may be corrected before operating the optical modulator 100 by controlling the heaters 171 and 172. Thus an amount of a phase shift due to the low-speed phase shifters 161 and 162 during the operation of the optical modulator 100 may be reduced and the power consumption in the optical modulator 100 may be reduced.

In the above-described embodiment, the low-speed phase shifters 161 and 162 are disposed in the parallel waveguides 121 and 122 respectively; however, one of the low-speed phase shifters 161 and 162 may be omitted. In such a case, a phase difference between lights passing through the parallel waveguides 121 and 122 may be changed by phase modulation performed only by one of the low-speed phase shifters 161 and 162.

In the above-described embodiment, the heaters 171 and 172 are disposed in the parallel waveguides 121 and 122 respectively; however, one of the heaters 171 and 172 may be omitted. In such a case, a phase difference between lights passing through the parallel waveguides 121 and 122 may be changed by phase modulation performed only by one of the heaters 171 and 172.

In the above-described embodiment, to adjust the temperatures of the parallel waveguides 121 and 122, the heaters 171 and 172 are used; however, the components for adjusting the temperatures of the parallel waveguides 121 and 122 are not limited to the heaters 171 and 172. For example, to adjust the temperatures of the parallel waveguides 121 and 122, a component for cooling the parallel waveguides 121 and 122 or the like may be used. In such a case, a phase difference between lights passing through the parallel waveguides 121 and 122 may also be changed by cooling the parallel waveguides 121 and 122.

As described above, the optical modulator reduces optical loss.

For example, a modulation operating point may be moved to an optimum point by the heaters 171 and 172 and fine adjustments may be performed by the low-speed phase shifters 161 and 162 that use the diodes. Specifically, a slight phase shift may be corrected by the low-speed phase shifters 161 and 162 that response at high speed, and a large phase shift may be corrected by the heaters 171 and 172 that cause no optical loss increase even if the amount of phase shift increases. With this structure, optical loss are reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical modulator comprising:
an optical wave guide that passes light;
a first phase shifter that adjusts a phase of the light passing through the optical waveguide by passing an electric current through a diode formed in the optical waveguide;
a second phase shifter that adjusts a phase of the light passing through the optical waveguide by adjusting a temperature of the optical waveguide; and
a controller that corrects a phase shift of the light passing through the optical waveguide based on a result of detection of power of the light that passed through the optical waveguide, the controller controls the first phase shifter to correct the phase shift when the magnitude of the phase shift of the light passing through the optical waveguide is less than a predetermined magnitude, and the controller controls the second shifter to correct the phase shift when the magnitude of the phase shift is greater than or equal to the predetermined magnitude.

2. The optical modulator according to claim 1, wherein
the optical waveguide includes a splitting section to split input light, waveguides to pass through the lights split by the splitting section, and an interference section to cause the lights that have passed through the waveguides to interfere with each other, and
the first phase shifter adjusts a phase difference between the lights passing through the waveguides by passing an electric current through the diode formed in at least one of the waveguides,
the second phase shifter adjusts a phase difference between the lights passing through the waveguides by adjusting the temperature of at least one of the waveguides,
the phase shift is a shift from a predetermined value of the phase difference between the lights that have passed through the waveguides, and
the controller determines whether the magnitude of the phase shift is less than the predetermined magnitude based on the power of light obtained by the interference of the lights in the interference section.

3. The optical modulator according to claim 2, wherein
the controller corrects the phase shift by controlling at least one of the first shifter and the second shifter so as to reduce the difference between the power of the lights obtained by the interference of the lights in the interference section.

4. The optical modulator according to claim 1, further comprising:
a data modulation section that performs phase modulation of the light passing through the optical waveguide in accordance with an input data signal.

5. The optical modulator according to claim 4, wherein
the controller corrects the phase shift by controlling the second phase shifter before the start of the phase modulation by the data modulation section.

6. The optical modulator according to claim 4, wherein
the controller corrects the phase shift by controlling the second phase shifter in a state no voltage is applied to the diode in the first phase shifter before the start of the phase modulation by the data modulation section.

7. The optical modulator according to claim 1, wherein
the second phase shifter is a heater.
